(19) United States
(12) Patent Application Publication
(10) Pub. No.: US 2012/0127120 A1
(43) Pub. Date: May 24, 2012

(54) TOUCH DEVICE AND TOUCH POSITION LOCATING METHOD THEREOF

(75) Inventors: YUNG-KUANG MIAO, Tainan County (TW); Yaw-Guang Chang, Tainan County (TW)

(73) Assignee: HIMAX TECHNOLOGIES LIMITED, Tainan County (TW)

(21) Appl. No.: 13/030,473

(22) Filed: Feb. 18, 2011

Related U.S. Application Data
(60) Provisional application No. 61/415,868, filed on Nov. 22, 2010.

(51) Int. Cl. G06F 3/041; G06F 3/044; G06F 3/045

(52) U.S. Cl. 345/174; 345/173

(57) ABSTRACT

A touch device and a touch position locating method thereof are provided. The touch position locating method includes the following steps. A plurality of target blocks are selected from a plurality of sensing blocks of a touch panel. The target blocks are detected at the same time to obtain a plurality of touch sensing data. Reference data is obtained according to the touch sensing data. Subtraction operations between the reference data and the touch sensing data are performed respectively, so as to obtain a plurality of adjusted touch sensing data. A location of a touch point on the touch panel is calculated according to the adjusted touch sensing data.

### CROSS-REFERENCE TO RELATED APPLICATION

This application claims the priority benefit of U.S. provisional application Ser. No. 61/415,868, filed on Nov. 22, 2010. The entirety of the above-mentioned patent application is hereby incorporated by reference herein and made a part of this specification.

### BACKGROUND

1. Field of the Invention

The invention relates to a touch device. Particularly, the invention relates to a touch device capable of reducing noise interference and a touch position locating method thereof.

2. Description of Related Art

Touch panels have a wide range of applications, for example, automatic teller machines, sales point terminals, industrial control systems, etc. With widespread of portable electronic products such as smart phones and personal digital assistants (PDAs), the touch panel also provides a more convenient input manner for those not familiar with key input, so that it has a very rapid market growth.

The touch panels are mainly divided into resistive touch panels and capacitive touch panels according to different physical principles for detecting touch points. The resistive touch panel may generate a voltage when a finger or a stylus touches the panel, and the capacitive touch panel may generate a tiny current when the finger touches the panel. Moreover, the capacitive touch panels can be further divided into surface capacitive touch panels and projected capacitive touch panels. The touch panel (for example, the capacitive touch panel) includes a plurality of sensing units. When the user's finger or a stylus touches a screen of the touch panel, a capacitance variation of the corresponding sensing unit is generated.

Generally, the touch panel is disposed on a display device, and when the user's finger or the stylus approaches or touches the sensing unit of the touch panel, the capacitance of the corresponding sensing unit is provided to a touch processor. The touch processor uses a sensing line to sense the capacitance of the corresponding sensing unit, and determines whether the user's finger or the stylus touches the touch panel or determines a touch position on the touch panel. Although a user can intuitively operate an electronic product based on a conventional integration method of the touch panel and the display device, when the touch panel is disposed on the display device, noises generated between touch panel and the display device may influence the touch processor in touch position determination, which may cause delay and error of touch response of the electronic product and greatly influence a usage feeling of the user.

### SUMMARY OF THE INVENTION

The invention is directed to a touch device and a touch position locating method thereof, which can avoid noises generated between a touch panel and a display device from influencing a touch position determination.

The invention provides a touch device including a touch panel, a touch detecting module and a processing module. The touch panel has a plurality of sensing blocks. The touch detecting module is coupled to the touch panel, and is used for selecting a plurality of target blocks from the sensing blocks and detecting the target blocks at the same time to obtain a plurality of touch sensing data. The processing module is coupled to the touch detecting module, and is used for performing subtraction operations between the touch sensing data and reference data to obtain a plurality of adjusted touch sensing data, so as to calculate a location of a touch point on the touch panel according to the adjusted touch sensing data, where the reference data is obtained according to the touch sensing data.

The invention provides a touch position locating method of a touch device, which includes the following steps. A plurality of target blocks are selected from a plurality of sensing blocks. The target blocks are detected at the same time to obtain a plurality of touch sensing data. Reference data are obtained according to the touch sensing data. Subtraction operations between the touch sensing data and the reference data are respectively performed to obtain a plurality of adjusted touch sensing data. A location of a touch point on the touch panel is calculated according to the adjusted touch sensing data.

In an embodiment of the invention, the reference data is touch sensing data having a minimum value in the touch sensing data of the target blocks.

In an embodiment of the invention, the reference data is an average of any two or more touch sensing data in the touch sensing data of the target blocks detected at the same time.

According to the above descriptions, in the invention, the sensing blocks are detected at the same time to obtain a plurality of touch sensing data, and accordingly obtain the reference data. Then, each batches of the touch sensing data detected at the same time is subtracted by the reference data, so as to reduce noise interference between the touch panel and the display device, and improve correctness of touch position determination of the touch panel.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a touch device according to an embodiment of the invention.

FIG. 2 is a flowchart illustrating a touch position locating method according to an embodiment of the invention.

### DETAILED DESCRIPTION OF DISCLOSED EMBODIMENTS

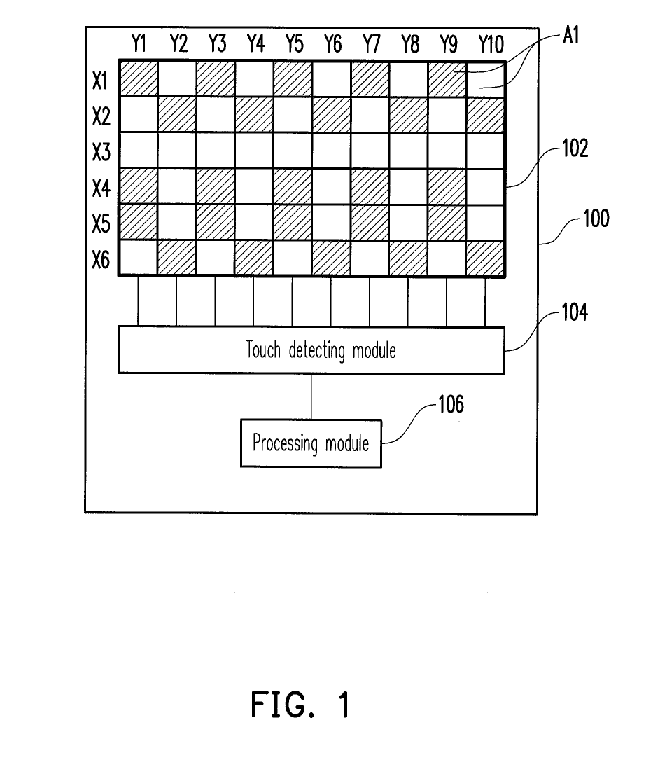

FIG. 1 is a schematic diagram of a touch device according to an embodiment of the invention. Referring to FIG. 1, the touch device 100 includes a touch panel 102, a touch detecting module 104 and a processing module 106. The touch panel 102 can be disposed on a display panel (not shown), and a user can directly view images displayed by the display panel through the touch panel 102. The touch panel 102 has a plurality of sensing blocks A1, which can generate sensing signals in response to touch operations of the user, where the touch panel 102 is, for example, a capacitive touch panel or a resistive touch panel.

The touch detecting module 104 is coupled to the touch panel 102, and is used for reading sensing signals of the sensing blocks A1 to detect a touch state of each of the sensing blocks A1, so as to obtain a plurality of touch sensing data, where the touch sensing data is, for example, a voltage signal or a current signal. In the present embodiment, the touch sensing module 104 selects a plurality of target blocks from the sensing blocks A1 and detects the target blocks at the same time to obtain a plurality of the touch sensing data. For example, the sensing blocks A1 of odd columns Y1, Y3, Y5, . . . , Y9 of a first row X1 are selected from the touch panel to serve as the target blocks, and then the touch detecting module 104 detects the target blocks at the same time to obtain a plurality of touch sensing data of the target blocks, and transmits the touch sensing data of the target blocks to the processing module 106. Then, the touch detecting module 104 changes to select the sensing blocks A1 of even columns Y2, Y4, . . . , Y10 of the first row X1 to serve as the target blocks, and then detects the target blocks at the same time to obtain touch sensing data of the target blocks and transmits the touch sensing data of the target blocks to the processing module 106. Deduced by analogy, the touch detecting module 104 sequentially drives/detects the sensing blocks A1 of the other rows, i.e. detects the sensing blocks A1 on the touch panel 102 in a sequence of the rows of X1, X2, X3, . . . , X6, though the invention is not limited thereto, and in an actual application, the sensing blocks A1 of multiple rows can be simultaneously driven/detected.

Moreover, according to a design of the touch detecting module 104, the touch detecting module 104 can detect all of the sensing blocks A1 of a same row at the same time, or can progressively detect the sensing blocks A1 of the same row. For example, in the present embodiment, all of the sensing blocks A1 of the same row are divided into two groups for detection. Namely, the touch detecting module 104 first detects the sensing blocks A1 of the odd columns of the same row (e.g. the sensing blocks A1 of the odd columns Y1, Y3, Y5, . . . , Y9 of the first row X1 in the touch panel 102) at the same time, and then detects the sensing blocks A1 of the even columns (e.g. the sensing blocks A1 of the even columns Y2, Y4, . . . , Y10 of the first row X1 in the touch panel 102) at another same time.

Moreover, the processing module 106 is coupled to the touch detecting module 104, and calculates a reference data according to a batch of the plurality of touch sensing data detected by the touch detecting module 104 at the same time, and then performs subtraction operations between the batch of the plurality of touch sensing data and the reference data to obtain a plurality of adjusted touch sensing data, so as to determine a touch state of the corresponding sensing block A1 according to the adjusted touch sensing data. After all of the plurality of touch sensing data of the sensing block A1 on the touch panel 102 are adjusted, the processing module 106 calculates a location of a touch point on the touch panel 102 according to the plurality of adjusted touch sensing data.

For example, in the present embodiment, it is assumed that the touch detecting module 104 detects the sensing blocks A1 of the odd columns Y1, Y3, Y5, Y7, Y9 of the first row X1 at the same time. The processing module 106 compares the touch sensing data provided by the touch detecting module 104, and finds a sensing block A1 of the third columns Y3 of the first row X1 (assuming a value of the touch sensing data thereof is S3) that has a minimum touch sensing data in the touch sensing data of the sensing blocks A1 of the odd columns Y1, Y3, Y5, Y7, Y9 of the first row X1. The processing module 106 then takes the touch sensing data S3 corresponding to the sensing block A1 of the third columns Y3 of the first row X1 as the reference data, and subtracts the touch sensing data S3 from the touch sensing data (assuming a value thereof is Sn, n=2x−1 and x is a positive integer) corresponding to each of the sensing blocks A1 of the odd columns Y1, Y3, Y5, Y7, Y9 of the first row X1, so as to obtain adjusted touch sensing data SA1, SA3, SA5, SA7, SA9 corresponding to each of the odd-column sensing blocks A1 of the first row X1, e.g. SA1=S1−S3, SA3=S3−S3, SA5=S5−S3, SA7=S7−S3 and SA9=S9−S3. Similarly, adjusted touch sensing data corresponding to the sensing blocks A1 of the even columns Y2, Y4, Y6, Y8, Y10 of the first row X1 and adjusted touch sensing data corresponding to the sensing blocks A1 of the other rows can also be obtained according to the same method, so that detailed descriptions thereof are not repeated.

Since each of the sensing blocks A1 detected at the same time endures the same noise interference generated between the touch panel 102 and the display device below the touch panel 102, by respectively subtracting the reference data with the same noise from the plurality of touch sensing data corresponding to each of the sensing blocks A1 detected at the same time, the plurality of adjusted touch sensing data removed with the noise interference can be obtained. In this way, the processing module 106 can locate/calculate the position of a touch point on the touch panel 102 according to the plurality of adjusted touch sensing data of the sensing blocks A1, so as to avoid delay and error of touch response of the touch device 100.

It should be noticed that the reference data is not limited to be the touch sensing data having the minimum value in the plurality of touch sensing data detected at the same time, and in other embodiments, the reference data can also be the touch sensing data having the second minimum value or a third minimum value in the plurality of touch sensing data detected at the same time, or one touch sensing data is randomly (arbitrarily) selected from the plurality of the touch sensing data detected at the same time to serve as the reference data. Alternatively, all of the plurality of the touch sensing data detected at the same time can be operated (e.g. average) to obtain the reference data. For example, two or more key data can be selected from the plurality of touch sensing data detected at the same time, and an average operation can be performed on the plurality of key data (touch sensing data) to obtain an average, and the obtained average is taken as the reference data. For example, the minimum and the second minimum touch sensing data are selected from the plurality of touch sensing data detected at the same time for the average operation, and the obtained average is taken as the reference data. Moreover, although a 6×10 pixel array is taken as an example for describing the touch device 100, it is only an exemplary embodiment, and a size of the pixel array in an actual application is not limited.

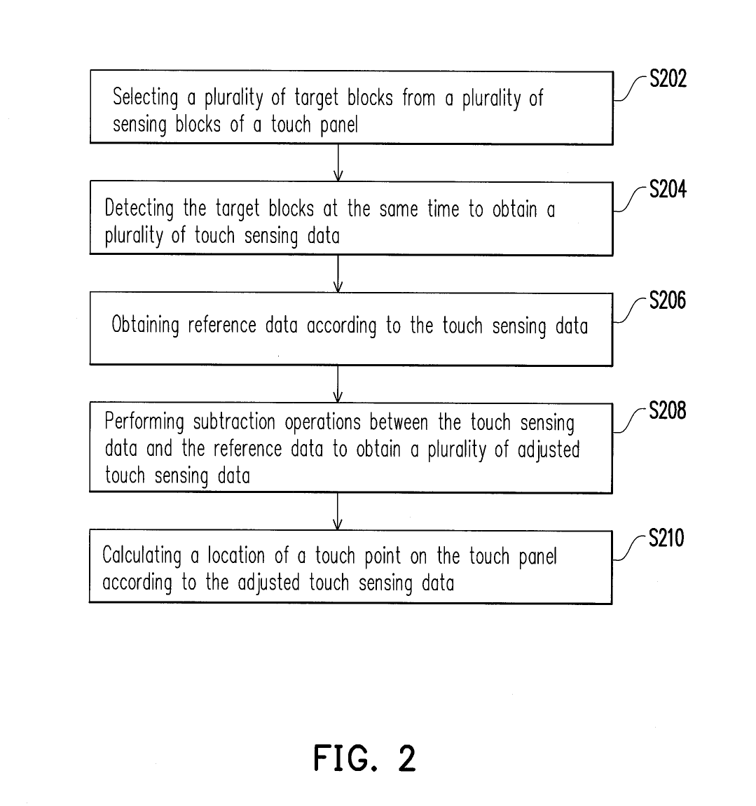

FIG. 2 is a flowchart illustrating a touch position locating method according to an embodiment of the invention. Referring to FIG. 2, the touch position locating method of the touch device 100 may include following steps. First, a plurality of target blocks are selected from a plurality of sensing blocks A1 of a touch panel (step S202). Then, the target blocks are detected at the same time to obtain a plurality of touch sensing data (step S204), where the touch sensing data are, for example, current signals or voltage signals, and a method for detecting the touch states of the sensing blocks A1 is, for example, to sequentially detect each row of the sensing blocks A1 row-by-row, though the invention is not limited thereto. According to a design of the touch detecting module 104, the sensing blocks A1 of a same row can be simultaneously detected or progressively detected. Then, a reference data are obtained according to the touch sensing data detected at the same time (step S206), where the reference data can be set to one of the plurality of the touch sensing data detected at the same time, or can be obtained by operating the plurality of touch sensing data detected at the same time (e.g. average operation). Then, subtraction operations between the plurality of the touch sensing data detected at the same time and the reference data are respectively performed to obtain a plurality of adjusted touch sensing data (step S208). Finally, a location of a touch point on the touch panel is calculated according to the plurality of adjusted touch sensing data (step S210).

In summary, in the invention, according to a characteristic that each of the sensing blocks endures the same noise interface generated between the touch panel and the display device at the same time, by obtaining the reference data according to a plurality of the touch sensing data corresponding to a plurality of sensing blocks detected at the same time, and by subtracting the reference data from each batch of the touch sensing data detected at the same time, the adjusted touch sensing data is obtained. In this way, influence of the touch state detection result due to the noise interference between the touch panel and the display device can be reduced, so as to improve correctness of touch position determination of the touch panel and avoid delay and error of touch response of the touch device.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch device, comprising:
a touch panel, having a plurality of sensing blocks;
a touch detecting module, coupled to the touch panel, for selecting a plurality of target blocks from the sensing blocks, and detecting the target blocks at the same time to obtain a plurality of touch sensing data; and
a processing module, coupled to the touch detecting module, for performing subtraction operations between the touch sensing data and a reference data to obtain a plurality of adjusted touch sensing data, and calculating a location of a touch point on the touch panel according to the adjusted touch sensing data, wherein the reference data is obtained according to the touch sensing data.

2. The touch device as claimed in claim 1, wherein the reference data is a touch sensing data having a minimum value in the plurality of touch sensing data of the target blocks.

3. The touch device as claimed in claim 1, wherein the reference data is an average of a part of or all of the plurality of touch sensing data of the target blocks.

4. The touch device as claimed in claim 1, wherein the touch panel is a capacitive touch panel or a resistive touch panel.

5. The touch device as claimed in claim 1, wherein the touch sensing data are current signals or voltage signals.

6. A touch position locating method of a touch device, wherein the touch device comprises a touch panel having a plurality of sensing blocks, the touch position locating method comprising:
selecting a plurality of target blocks from the sensing blocks;
detecting the target blocks at the same time to obtain a plurality of touch sensing data;
obtaining reference data according to the touch sensing data;
performing subtraction operations between the touch sensing data and the reference data to obtain a plurality of adjusted touch sensing data; and
calculating a location of a touch point on the touch panel according to the adjusted touch sensing data.

7. The touch position locating method as claimed in claim 6, wherein the step of obtaining the reference data according to the touch sensing data comprises:
comparing the plurality of touch sensing data to obtain a minimum value from the plurality of touch sensing data; and
taking the minimum value as the reference data.

8. The touch position locating method as claimed in claim 6, wherein the step of obtaining the reference data according to the touch sensing data comprises:
selecting a plurality of key data from the plurality of touch sensing data;
calculating an average of the key data; and
taking the average as the reference data.

9. The touch position locating method as claimed in claim 6, wherein the touch panel is a capacitive touch panel or a resistive touch panel.

10. The touch position locating method as claimed in claim 6, wherein the touch sensing data are current signals or voltage signals.
